(19) United States
(12) Patent Application Publication
(10) Pub. No.: US 2008/0145185 A1
(43) Pub. Date: Jun. 19, 2008

(54) TWO PIECE, FREE RUNNING, PREVAILING TORQUE NUT

(75) Inventors: DAVID HOCKING, SIGNAL HILL, CA (US); WILLIAM O. FIELDS, BUENA VISTA, CA (US); ERNEST MONSERRATT, SAN GABRIEL, CA (US); DAVID SILVER, TORRANCE, CA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(73) Assignee: ALCOA GLOBAL FASTENERS, TORRANCE, CA (US)

(21) Appl. No.: 11/610,459

(22) Filed: Dec. 13, 2006

(51) Int. Cl. F16B 39/00

(52) U.S. Cl. 411/436

(57) ABSTRACT

A threaded fastener having a two-piece nut member and a bolt with the nut member having a threaded nut member and a base member is disclosed. The threaded nut member has a body portion and a neck portion, the neck portion engaging with a transition beginning engagement on the base member. The base member includes a transition portion, the diameter of the transition portion increasing radially as it extends axially from the cylindrical through bore portion to an increased diameter at the outer planar surface of the base member. Movement of the neck potion into the based member results in the threaded form having a compressive engagement with engaged threads of the bolt to provide the prevailing torque structure. The threaded nut member and base member may be made of dissimilar materials and is more flexible in use with varying bearing surfaces.

### BACKGROUND

1. Field

The present disclosure relates to an improved torque nut fastener. In exemplary embodiments, the present disclosure relates to a two-piece torque nut having a threaded nut member and a base member, the torque nut having a prevailing torque feature when installed.

2. General Background

Threaded fasteners are utilized in variety of applications. Such fasteners include bolts and nut members having a matching threaded form for attachment. In particular applications, for example, aerospace applications, these fasteners are subject to vibration and load fluctuations causing fasteners to lose retention torque causing loosening. Frequently, a prevailing torque feature is accomplished by deforming a portion of the internal thread to cause a certain level of friction between the nut and the bolt. This will hold together the bolt and nut resisting loosening of the fastener.

In standard fasteners having two-piece nut engagements, there are variations in the tolerances between the nut and the bolt. For example, a bolt may possess a thread tolerance that resides at the low end of the range while the nut thread tolerance may be at the high end. As a result, the torque on the fastener is inconsistent and may not reach the required torque specifications.

Another problem may occur if the bolt thread is at the high end of its permissible range and the nut thread is at the low end of its permissible range. As a result, the maximum torque on the fastener can be exceeded. In these previous designs, higher torque values could freeze the nut at any given position on the bolt. Therefore, the fastener would not meet the preload requirements.

To offset this problem, fasteners have been manufactured with small variances in tolerances, raising costs. Additionally, the performance of standard threaded fasteners may vary with the material type of the mating component and performance can only be guaranteed if the material type of the mating component is controlled. Accordingly, there must be separate designs utilized for every different application.

Thus, there is a need to provide a locking torque nut that may be utilized with a variety of different pins and bolts, the bolts having different variations in thread pitches and tolerances.

There is also a need to provide a nut member having two pieces that may be joined together. By attaching the threaded member to the base member, the ease and speed of the installation is increased.

Additionally, there is a need to provide a fastener having a two-piece torque nut that is constructed from different materials, allowing for more flexibility and cost effective use with different types of bearing surfaces.

### SUMMARY

In one aspect of the present disclosure, a nut member is disclosed. The nut member includes two separate pieces, a threaded member and a base member. The base member has a throughbore, cylindrical counterbore portion and a transition portion. The transition portion has an increased diameter as it extends from the cylindrical through bore portion to the outer surface of the base member.

The threaded member of the nut member has a neck portion and a body portion, and the threaded bore extends through the threaded member. The outer diameter of the neck portion is less than the diameter of the transition portion of the base member at its outer surface allowing the nut member to be fitted with the base member prior to installation.

Upon installation of the nut member, the neck portion of the threaded nut member is moved into the transition portion and then the through bore portion of the base member. As the leading edge of the neck portion moves into the base member, the neck portion moves radially inward into a compressive engagement with the engaged threads of the bolt. As a result, the fastener is held together with a high prevailing torque.

In another aspect, the threaded member is attached to the base member for ease and increased speed of installation. The threaded member may be attached to the base member in a number of different ways, including adhesives, friction, and staking, as well as other attachment techniques.

In another aspect, a fastener is disclosed having a bolt and a two-piece nut member to secure together a plurality of workpieces. The fastener is installed in holes located in the plurality of workpieces. The bolt includes a shank having a smooth shank portion and a thread portion.

In a further aspect, a fastener is disclosed that has the capability of being installed in composite, metallic, or composite/metallic structures. For example, the disclosed fastener could be installed in steel, composites, titanium, aluminum, or a mixture of these components.

In another aspect, the disclosed nut member may be utilized with a variety of existing bolts and pins and a variety of thread forms, including low, medium and high thread pitch diameters.

In another aspect, the threaded portion and the base member of the nut member can be constructed from dissimilar materials. In exemplary embodiments, the threaded nut member may be constructed of a material that is stronger to maximize physical performance of the fastener.

Additionally, the base member may be constructed of lighter and less expensive materials. As a result, the weight of the fastener is reduced, making the fastener more cost-effective for use with aerospace applications.

In a further aspect a fastener is disclosed that includes a free running nut which also provides a prevailing torque feature upon installation. The nut member is free running along the threaded portion of the bolt prior to the neck portion of the nut member entering the base member.

Other objects, features, and advantages of the present disclosure will become apparent from the subsequent description and the appended claims.

### DRAWINGS

The foregoing aspects and advantages of present disclosure will become more readily apparent and understood with reference to the following detailed description, when taken in conjunction with the accompanying drawings, wherein:

FIG. 1 illustrates an exemplary embodiment of the torque nut illustrating the threaded nut member and the base member in an unattached exploded view.

FIG. 2 illustrates an embodiment of the torque nut, the threaded nut member and base member connected for ease and speed of installation.

FIG. 3 illustrates a sectional view of an exemplary embodiment of the fastener prior to installation, including the threaded nut member and the base member.

FIG. 4 illustrates a sectional view of another exemplary embodiment of the fastener prior to installation, including the threaded nut member and the base member.

FIG. 5 illustrates the sectional view of an uninstalled fastener comprising the bolt and the nut member prior to installation of the workpieces.

FIG. 6 illustrates a sectional view of the exemplary fastener after pre-installation, with the plurality of workpieces slightly clamped together.

FIG. 7 illustrates a partial sectional view of the fastener showing an enlarged scale of the portion of the nut member and the threaded portion of the bolt in a final installed condition.

FIG. 8 illustrates a partial sectional view of the installed nut member showing the threaded nut member and the base member in a final installed condition.

### DETAILED DESCRIPTION

A fastener for securing together a plurality of workpieces 105, 110 and adapted to be located in holes 115, 120 in such workpieces is disclosed. In exemplary embodiments, the fastener includes a bolt 15, and a two-piece nut member 20. In exemplary embodiments, the workpieces 105, 110 can be formed with a plurality of different materials, the materials including composite, metallic, or composite/metallic structures, any combination thereof. In particular embodiments, the workpieces 105, 110 may be constructed from steel, titanium, aluminum, composites, or any combination thereof.

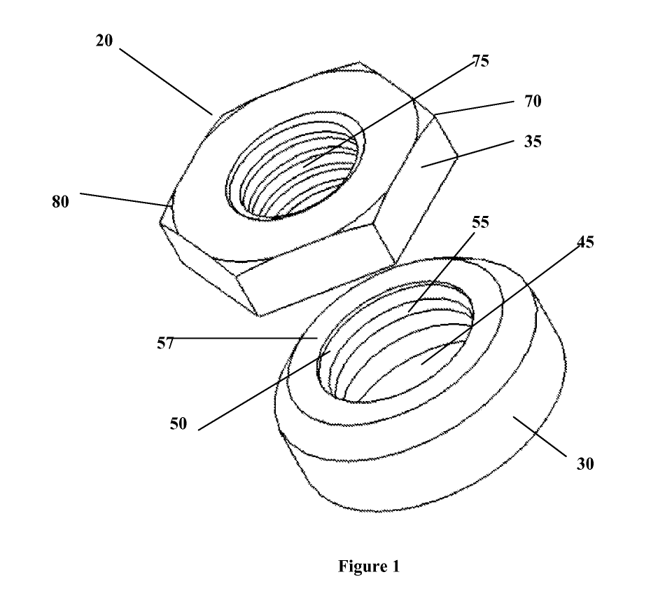

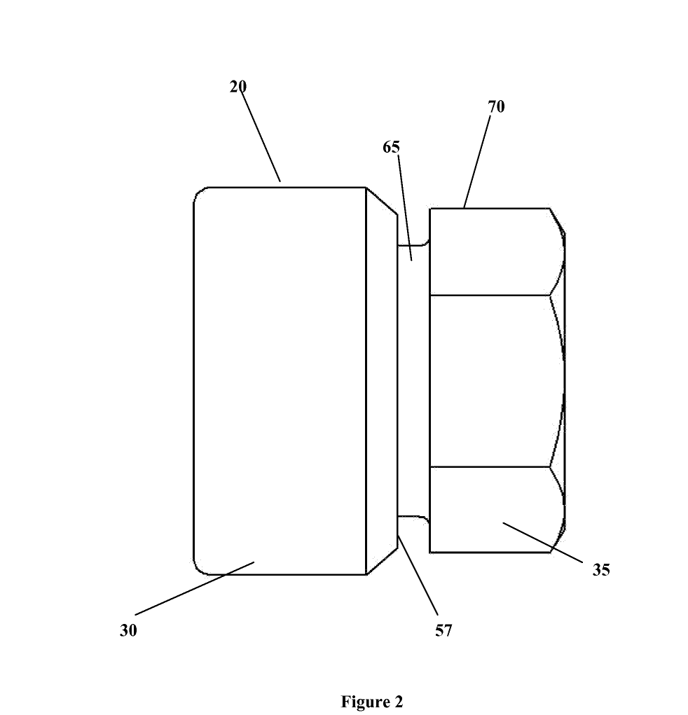

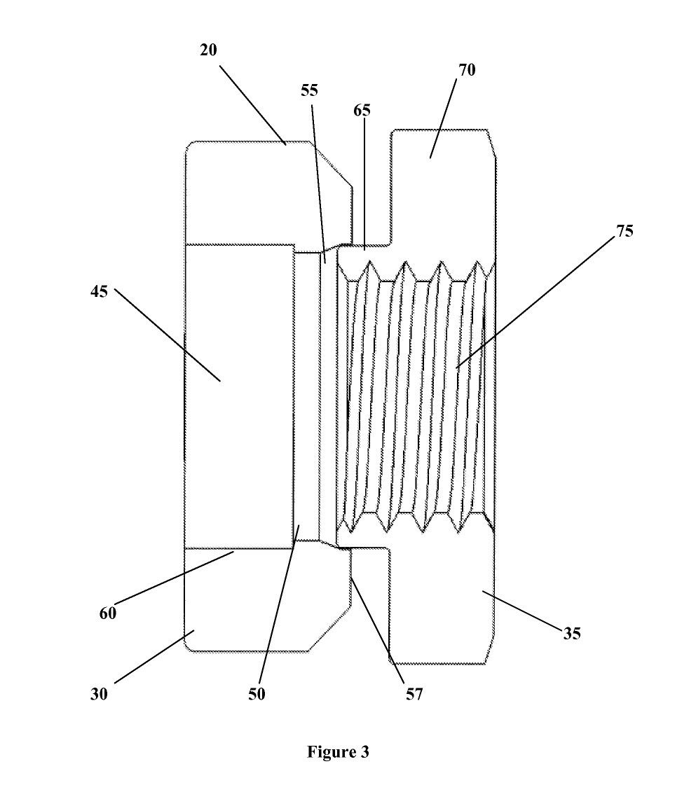

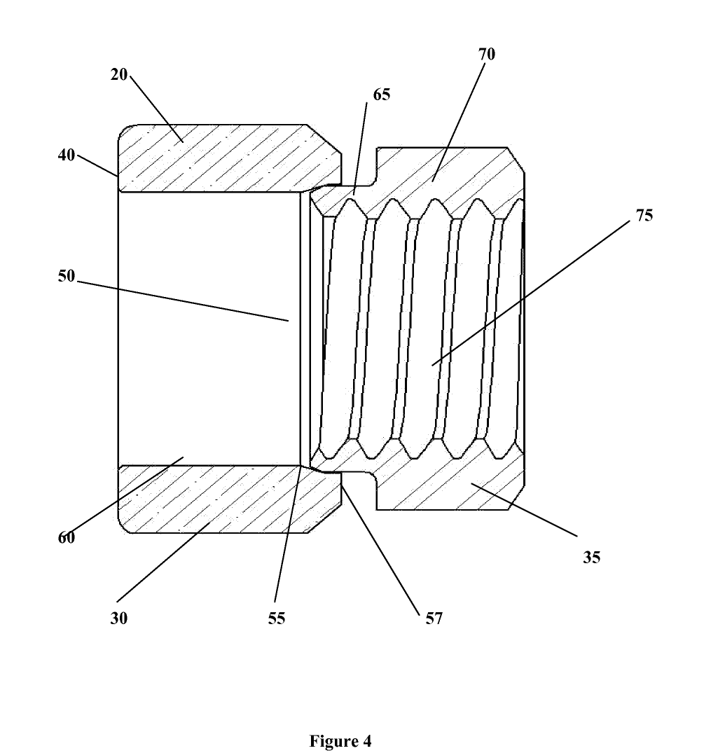

As depicted in FIGS. 1-4, the nut member 20 is a two piece construction having separate portions including a base member 30 and a threaded nut member 35. The base member 30 includes a counterbore 45 to allow the bolt member 15 to extend through the base member 30.

The base member 30 of the nut member includes a counterbore 45 that is adapted to allow the bolt of the fastener to extend through. At one end of the base member 30 is an outer surface 40 for engagement with an outer surface 125 of the workpieces 105, 110. On the opposite end of the base member 30 is a beginning engagement transition segment 50 that engages the threaded nut member 35.

The transition segment 50 extends axially and radially inward from the outer surface 57 of the base member 20 to a cylindrical through bore portion 55 of the base member 20. The diameter of the transition portion of the base member decreases as it moves axially towards the cylindrical through bore portion 55 of the base member.

In exemplary embodiments, the transition portion 50 may be tapered and have an angle of less than or equal to 40° from the throughbore as the diameter decreases radially from the outer surface 57 to the through bore 55. In the embodiment illustrated, the diameter of the transition portion 50 is tapered and decreases in a uniform fashion.

However, the transition portion can be any shape as long as the diameter decreases as it moves axially toward the cylindrical through bore portion of the base member. For examples, the transition portion could be a decreased shape such as a convex curve, a concave cure, or an s-shaped curve, or be any configuration that would cause a reduction in the diameter of the neck portion of the mating threaded nut member.

Following the cylindrical through bore portion 55 is cylindrical counterbore portion 45. The counterbore portion 45 may have a diameter greater than that of the cylindrical through bore portion 55. The counterbore portion 45 of the base member 30 extends from the cylindrical through bore portion 55 to the outer surface 40 of the base member 30 that is in bearing with the outer surface 125 of the workpieces 105, 110.

The diameter of the cylindrical through bore portion 55 is fabricated with very close tolerances to provide consistency in deformation and to not exceed pre-described torque loads. As a result, over loading is controlled during installation and pre-load targets are achieved.

The threaded nut member 35 has a neck portion 65 and a body portion 70. The body portion 70 includes a threaded throughbore 75 through the body portion 70 and neck portion 65 and can readily be applied to the threaded part of the bolt 15. The body portion 70 has a hexagonal shape 80 on its outer surface to facilitate engagement of the head of a standard socket tool (not shown) whereby torque may be applied to the nut member 20. However, the shape of the body portion is not limited to a hexagonal shape. In other embodiments, the shape may be a square or other suitable shape to apply torque.

The neck portion 65 has an outer diameter less than the diameter of the transition portion 50 at the outer surface of the base member. This allows the neck portion to fit into the base member 30 of the nut prior to installation. This allows the two pieces of the nut member 20 to be fitted together prior to installation.

In particular embodiments, the surface finish of the threaded nut member 35 and base member 30 can be independently adjusted. As a result, the torques and preload characteristics of the fastening assembly can be optimized.

In some embodiments, it is advantageous to attach the base member 30 to the threaded nut member 35. In a particular embodiment, the base member 30 is attached to the threaded nut member 35 by means of an adhesive 85. The attachment can also be accomplished in several other techniques. The threaded nut member 35 may also be attached to the base member 30 by friction, staking and other suitable methods known by those skilled in the art.

Attaching the base member 30 to the threaded nut member 35 is an improvement over prior art fasteners having a two piece construction. Previously, the two pieces would be shipped separately or loosely. As a result, parts were easy to lose. Additionally, the installation of the fastener was made much more difficult. The parts would have to be connected by an individual before installation. By attaching the two components prior to shipping, the nut member acts as a single, one-piece part increasing the speed and ease of installation, but also provides the flexibility of the two-piece fastener.

In particular embodiments, as it is preferred that the nut member 20 be of a two-piece construction, the base member 30 and threaded nut member 35 may be formed from different materials. The threaded nut member 35 may be constructed from higher strength materials to maximize the physical characteristics of the fastener. The base member 30 may be constructed of different materials that are lighter or more cost effective or other compatible materials. By constructing the base member 30 of the nut with lighter materials, the unit weight of the fastener is reduced. Accordingly, the fastener is more useful for particular applications, including aerospace applications.

Allowing the threaded nut member 35 and the base member 30 to be constructed from dissimilar materials permits the fastener to be used in many different applications. As a result, the nut member 20 can also be used with a variety of different pins or bolts. For example, the nut member 20 in the present disclosure can be utilized with bolts having low, medium and high thread pitch diameters. The fastener becomes much more flexible in use.

Additionally, the bearing surfaces may be formed from a variety of different materials. For example, the disclosed fastener 10 may be utilized on bearing surfaces including aluminum, composites, steel and many other materials. Prior art fasteners are designed and qualified on only one pin and one bearing surface. The design of this fastener is therefore an improvement over such prior art fasteners.

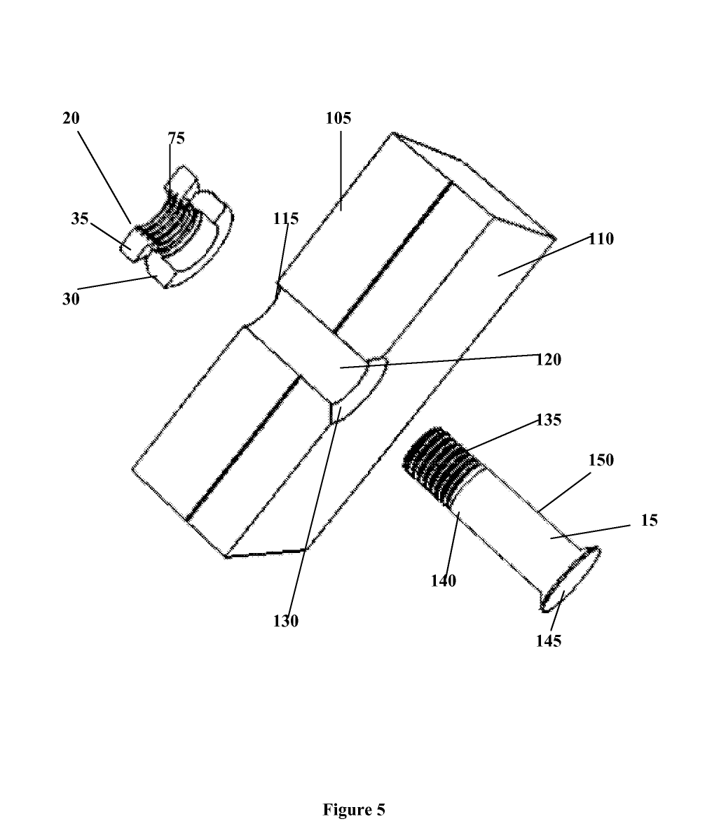

As illustrated in FIG. 5, the nut member 20 is to be assembled with a bolt 15 to secure the workpieces 105, 110. The bolt 15 has an elongated shank 140 with an enlarged head 145 at one and a threaded portion 135 at the opposite end. A smooth shank portion 150 connects the threaded portion 135 with the bolt head 145. The shank 140 of the bolt is adapted to extend through holes 115, 120 in the plurality of workpieces 105, 110. In particular embodiments, the hole 115 has a countersunk portion 130 adapted to receive a coutersink head on the bolt. In other embodiments, the head of the bolt is simply a flanged end to engage the outer surface of the fastener. The threaded shank portion 135 of the bolt 15 has a substantially uniform thread form 155 adapted to be received by the threaded throughbore 75 of the threaded nut member 35 of the nut member 20.

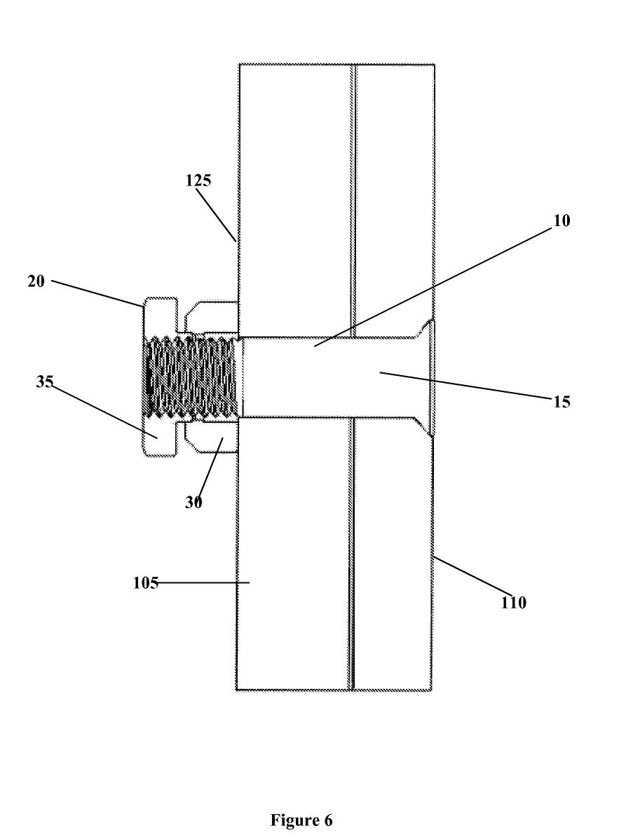

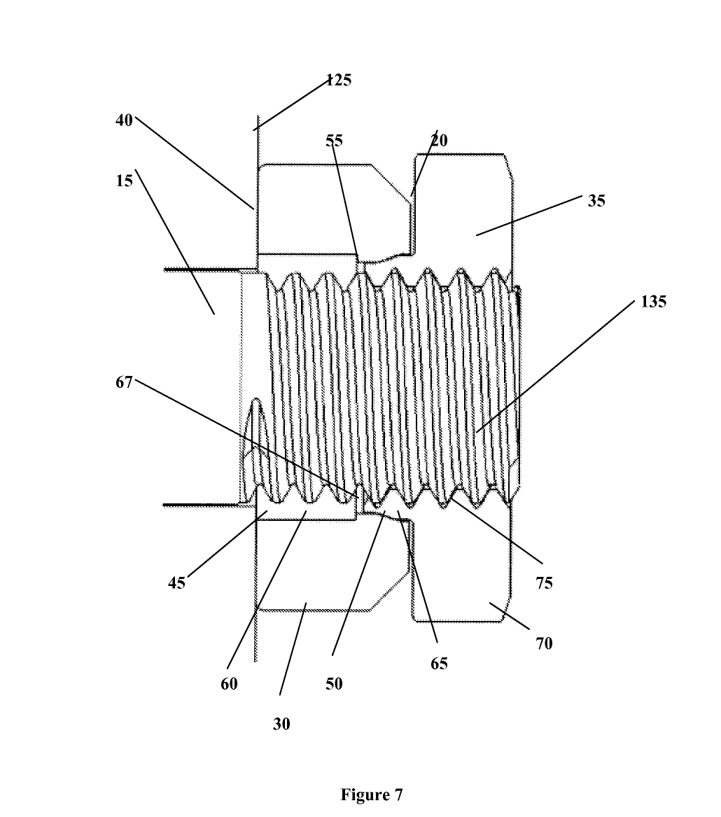

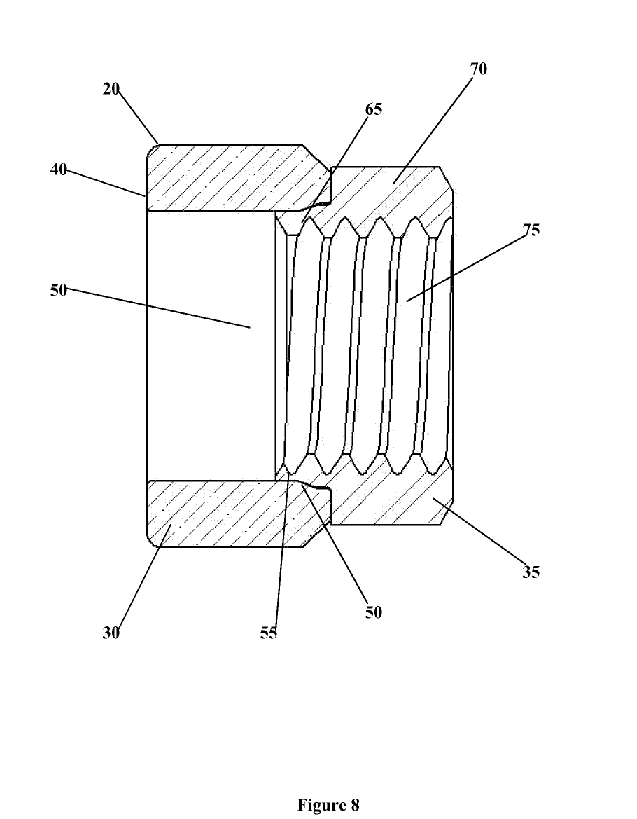

Looking now to FIGS. 6-8, the nut member 20 is shown in assembled relationship with a bolt 15 to define a fastener 10 securing two workpieces 105, 110 together. The nut member 20 has been threadably secured onto the threaded portion 135 of the bolt by torque applied via the hexagonal head portion of the body portion of the threaded nut member. A suitable tool (not shown) allows clamping of the plurality of workpieces together under a preselected torque.

During installation of the fastener 10, the nut member 20 can be applied to the bolt 15 by a suitable tool or by hand to initially thread the nut section onto the threaded portion of the bolt shank. With the base member 30 of the nut member 20 in engagement with the outer surface of the workpieces 105, a desired magnitude of initial clamp load is achieved by the application of a first predetermined magnitude of torque. At this point the threaded nut member 35 is essentially free running along the threaded portion of the bolt shank.

With the base member 30 of the nut member 20 in engagement with the outer surface 125 of the workpiece 105, torque is applied to the threaded nut member 35, moving the neck portion 65 of the threaded nut member 35 axially into the transition portion 50 of the base member. As the neck portion 65 of the threaded nut member 35 enters the transition beginning engagement 50 of the base member 30, the leading edge 67 of the neck portion 65 of the thread nut member 35 is moved radially inward along the transition engagement 50 until it reaches the cylindrical through bore portion 55 of the base member 30. As the leading edge 67 of the neck member enters the cylindrical through bore 55, the leading edge of the neck portion 65 is moved into compressive engagement with the threaded portion of the bolt 15.

The threaded nut member 35 will slightly deform to the shape of the threaded portion of the bolt 135 in response to the compressive engagement as the neck portion 65 is moved into the base member 30. The design of the fastener 10 is optimized so that the engaged threads of the shank portion of the bolt 15 remain substantially undistorted.

The result is a fastener 10 holding the workpieces 105, 110 together at under a pre-selected magnitude of final clamp load and with the engaged threads of the nut 20 and bolt 15 of the installed fastener 10 held together under a high compressive load resulting in a high prevailing torque. This provides a desired resistance from removal and loosening of the fastener 10 from vibration or other loading.

In particular embodiments, the workpieces 105, 110 have a total thickness which is the total minimum thickness of the grip range of the fastener 10. In this application, the smooth shank portion of the bolt 15 will extend past the outer surface of the workpiece and partially into the counterbore section 45 of the base member 30. In other embodiments, the workpieces 105, 110 have a total thickness which is the maximum thickness of the grip range of the fastener 10. As can be seen in FIG. 6, at this point there is complete engagement of substantially all of the threads in the threaded bore 75 of the threaded nut member 35 with the threaded portion of the bolt 15.

While the above description contains many particulars, these should not be considered limitations on the scope of the disclosure, but rather a demonstration of embodiments thereof. The fastener and uses disclosed herein include any combination of the different species or embodiments disclosed. Accordingly, it is not intended that the scope of the disclosure in any way be limited by the above description. The various elements of the claims and claims themselves may be combined any combination, in accordance with the teachings of the present disclosure, which includes the claims.

What is claimed is:

1. A two-piece nut member comprising:
a base member and a threaded nut member;
the base member having a cylindrical counterbore portion; a cylindrical through bore portion having a generally uniform preselected diameter, and a transition portion, the diameter of the transition portion increasing radially as it extends axially from the cylindrical through bore portion to an increased diameter at the outer planar surface of the base member;
the threaded nut member having a body portion; a neck portion with an outer diameter less than the increased diameter of the transition portion of the base member; and a through bore with a thread formed therein, the through bore extending the length of the threaded nut member; and
wherein the neck portion of the threaded nut member is moved into the transition portion and then the cylindrical through bore of the base member, the diameter of the cylindrical through bore portion adapted to provide an interference between the helical thread of the neck portion and the threaded portion of a bolt when applying a radially compressive force between the nut member and the threaded portion of the bolt.

2. The nut of claim 1 wherein the base member and threaded nut member are pre-joined to increase the speed and ease of installation.

3. The nut of claim 2 wherein the base member is pre-joined to the threaded nut member by an attachment means selected from the group comprising adhesives, staking, friction or other attachment means.

4. The nut of claim 1 wherein the base member and the threaded nut member are constructed from different materials.

5. The nut of claim 4 wherein the base member is pre-joined to the threaded nut member by an attachment means selected from the group comprising adhesives, staking, friction or other attachment means.

6. The nut of claim 5 wherein the base member is pre-joined to the threaded nut member by an attachment means selected from the group comprising adhesives, staking, friction or other attachment means.

7. The nut of claim 1 wherein an axial length of the neck portion of the threaded nut member is no greater than the combined axial length of the transition portion and cylindrical through bore portion.

8. The nut of claim 1 wherein the nut member will be secured to the threaded portion of the bolt with a magnitude of prevailing torque.

9. The nut of claim 1 wherein the plurality of workpieces are selected from the group consisting of steel, titanium, aluminum, composites, or any combination thereof.

10. The nut of claim 1 wherein the nut member is compatible with a bolt having low, medium, and high thread pitch diameters.

11. The nut member of claim 1 wherein the body portion is adapted for applying relative torque between the nut member and the bolt.

12. The nut member of claim 1 wherein the transition portion is tapered at an angle of less than 40°.

13. A fastener for securing together a plurality of workpieces and adapted to be located in holes of a plurality of workpieces, the fastener comprising:
a bolt, the bolt having a shank with a threaded shank portion and a smooth shank portion;
a two-piece nut member, the nut member including a base member and a threaded nut member;
the base member having a cylindrical counterbore portion; a cylindrical through bore portion having a generally uniform preselected diameter, and a transition portion, the diameter of the transition portion increasing radially as it extends axially from the cylindrical through bore portion to an increased diameter at the outer planar surface of the base member;
the threaded nut member having a body portion; a neck portion with an outer diameter less than the increased diameter of the transition portion of the base member; and a through bore with a thread formed therein, the through bore extending the length of the threaded nut member; and
wherein the neck portion of the threaded nut member is moved into the transition portion and then the cylindrical through bore of the base member, the diameter of the cylindrical through bore portion adapted to provide an interference between the helical thread of the neck portion and the threaded portion of a bolt when applying a radially compressive force between the nut member and the threaded portion of the bolt.

14. The fastener of claim 13 wherein the base member and threaded nut member are pre-joined to increase the speed and ease of installation.

15. The fastener of claim 14 wherein the base member is pre-joined to the threaded nut member by an attachment means selected from the group comprising adhesives, staking, or friction.

16. The fastener of claim 13 wherein the base member and the threaded nut member are constructed from different materials.

17. The fastener of claim 16 wherein the base member is pre-joined to the threaded nut member by an attachment means selected from the group comprising adhesives, staking, friction or other attachment means.

18. The fastener of claim 17 wherein the base member is pre-joined to the threaded nut member by an attachment means selected from the group comprising adhesives, staking, friction or other attachment means.

19. The fastener of claim 13 wherein an axial length of the neck portion of the threaded nut member is no greater than the combined axial length of the transition portion and cylindrical through bore portion.

20. The fastener of claim 13 wherein the nut member will be secured to the threaded portion of the bolt with a magnitude of prevailing torque.

21. The fastener of claim 13 wherein the plurality of workpieces are selected from the group consisting of steel, titanium, aluminum, composites, or any combination thereof.

22. The fastener of claim 13 wherein the nut member is compatible with a bolt having low, medium, and high thread pitch diameters.

23. A fastener for securing together a plurality of workpieces and adapted to be located in holes of a plurality of workpieces, the fastener comprising:
a bolt, the bolt having a shank with a threaded shank portion and a smooth shank portion;
a two-piece nut member, the nut member including a base member and a threaded nut member;
the base member having a cylindrical counterbore portion; a cylindrical through bore portion having a generally uniform preselected diameter, and a transition portion, the diameter of the transition portion increasing radially as it extends axially from the cylindrical through bore portion to an increased diameter at the outer planar surface of the base member;
the threaded nut member having a body portion; a neck portion with an outer diameter less than the increased diameter of the transition portion of the base member; and a through bore with a thread formed therein, the through bore extending the length of the threaded nut member; and
wherein the neck portion of the threaded nut member is moved into the transition portion and then the cylindrical through bore of the base member, the diameter of the cylindrical through bore portion adapted to provide an interference between the helical thread of the neck portion and the threaded portion of a bolt when applying a radially compressive force between the nut member and the threaded portion of the bolt; and
wherein the nut member is free running onto the threaded portion of the bolt to clamp the workpieces together prior to the neck portion moving into the base member.

24. The fastener of claim 23 wherein the base member and threaded nut member are pre-joined to increase the speed and ease of installation.

25. The fastener of claim 24 wherein the base member is pre-joined to the threaded nut member by an attachment means selected from the group comprising adhesives, staking, or friction.

26. The fastener of claim 23 wherein the base member and the threaded nut member are constructed from different materials.

27. The fastener of claim 26 wherein an axial length of the neck portion of the threaded nut member is no greater than the combined axial length of the transition portion and cylindrical through bore portion.

28. The fastener of claim 27 wherein the nut member will be secured to the threaded portion of the bolt with a magnitude of prevailing torque.

29. The fastener of claim 23 wherein the plurality of workpieces are selected from the group consisting of steel, titanium, aluminum, graphite composites, or any combination thereof.

30. The fastener of claim 23 wherein the nut member is compatible with a bolt having low, medium, and high thread pitch diameters.
